(19) United States
(12) Patent Application Publication
(10) Pub. No.: US 2006/0208133 A1
(43) Pub. Date: Sep. 21, 2006

(54) Personal aircraft vehicle

(76) Inventor: Kenneth A. Ligo, Freehold, NJ (US)

Correspondence Address: Charles I. Brodsky, 2 Bucks Lane, Marlboro, NJ, 07746, US

(21) Appl. No.: 11/371,279

(22) Filed: Mar. 9, 2006

Related U.S. Application Data
(60) Provisional application No. 60/662,866, filed on Mar. 18, 2005.

(51) Int. Cl. B64C 27/08

(52) U.S. Cl. 244/17.23

(57) ABSTRACT

A personal aircraft vehicle functioning as a vertical take-off or landing vehicle having all the attributes of a standard motorcycle in the way it functions and appears, but differing therefrom in that it incorporates no wheels whatsoever, and is capable of three dimensional travel.

### CROSS-REFERENCE TO RELATED APPLICATIONS

A provisional application describing this invention was filed Mar. 18, 2005 and assigned Ser. No. 60/662,866.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to personal aircraft vehicles, in general, and to one which functions as a vertical take-off or landing vehicle for one person use, in particular.

2. Description of the Related Art

As will be appreciated, in order for a person to participate in the recreational activities of hang-gliding or of flying an ultralight, he or she must be able to travel to a cliff, mountain, or very high hill, on the one hand, or to be able to get to an airport runway, on the other hand; this is oftentimes not easy to do. Additionally, in order to participate with any degree of proficiency, air currents and temperatures must be just right—otherwise the possible pleasures attendant with these activities could suffer drastically. One further drawback for these activities to obtain a wider degree of participation, furthermore, follows from the understanding that many possible adherents to the sport suffer from fear of heights.

As will become clear from the following description, the personal aircraft vehicle of this invention expands these endeavors by allowing for a “take-off” to be had right on one's driveway, yard, or street—and to elevate to heights of the order of 100-200 feet, and less. As will be seen, the vehicle possesses substantially all the attributes of a standard motorcycle in the way it functions and appears—yet, without having any wheels, it is capable of left-right-up-and-down travel essentially as a vertical “take-off” or “landing” vehicle.

### SUMMARY OF THE INVENTION

The Personal Aircraft Vehicle of the present invention will be seen to operate through the use of a pair of powerful ducted propeller units for lift—one of which is positioned in front of the vehicle's handlebars, with the other being behind the rider's seat. Both propeller units will be seen to be above the vehicle's center of gravity, as well as that of the rider, providing a positioning affording appropriate balance in keeping the rider and vehicle upright and stable. Controllable inflight-variable pitch propellers are employed in ducts to control propulsion for up, down, left, right and forward travel. As will be seen from the following description, the controllable inflight-variable pitch propellers can be independently adjusted both in the front duct and well as in the rear duct, eliminating the need for engine throttle changes. As will be appreciated by those skilled in the art, a major advantage to this is that constant and maximum horsepower can be applied at all times during operation. Travel left to right for steering purposes can be achieved by a means of directing the flow of thrust to the left or right of the craft, thereby redirecting the craft's direction as to the left or right. Swiveling of flat airfoils, also known as vanes by those skilled in the art, are located in the flow of thrust, beneath the ducts, and is one such means of directing the flow of thrust in such a manner. Other means of directing the flow of thrust for steering, and maneuvering, can be devised, and as the technology of such advances may occur in the future.

### BRIEF DESCRIPTION OF THE DRAWINGS

These and other features of the present invention will be more clearly understood from a consideration of the following description, taken in connection with the accompanying drawings, in which:

FIGS. 1, 2 and 3 respectively show side, top and front views of the personal aircraft vehicle of the invention as it would be capable of three-dimensional, left-right, up-down, front-rear travel; and

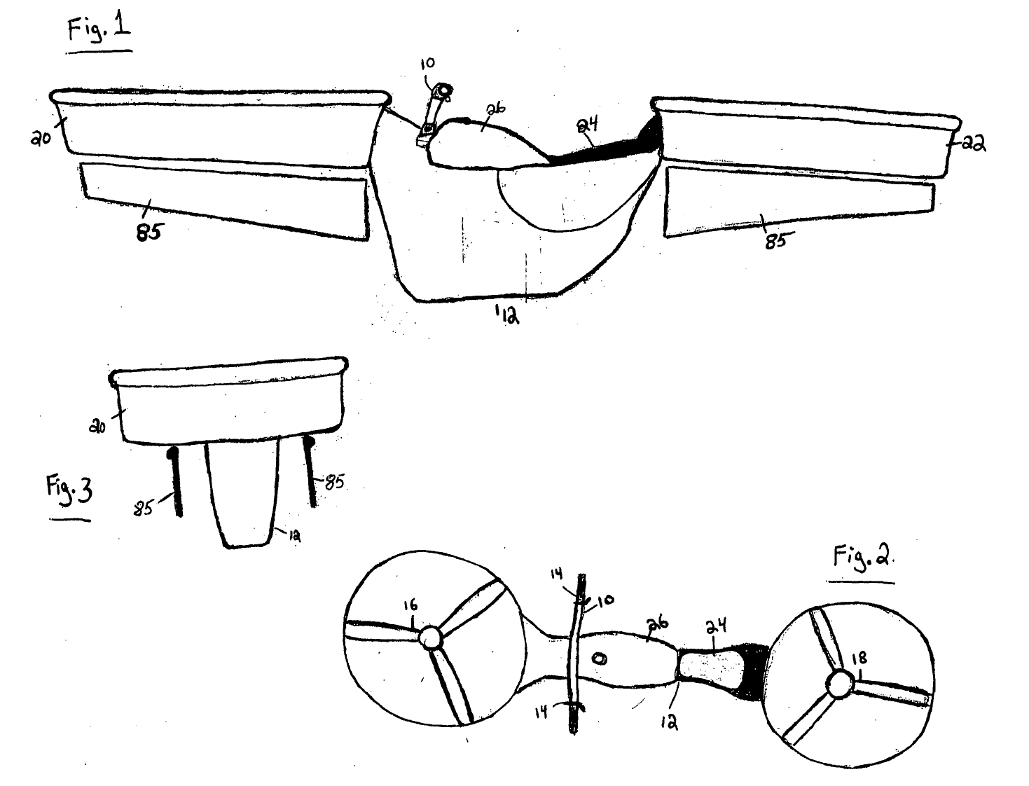

FIGS. 4-5 are helpful in an understanding of the construction and operation of the invention.

### DETAILED DESCRIPTION OF THE INVENTION

As will be appreciated, the personal aircraft vehicle of the invention represents not only a new recreational activity, but a way for more and more people to get around in the future as roadways are becoming more and more crowded. As will also be appreciated, although described in the context for “personal use”, its features and teachings can be expanded for inclusion in developing a “family” vehicle in carrying increased number of passengers. Emergency personnel as well may find usefulness in this type of craft from its all-terrain capabilities, including over water travel. Affording the features of vertical take-off and landing, the craft takes on the attributes and appearance of a motorcycle, and utilizes only few controls which can be easily mastered after only small amounts of practice so as to provide a feel for its control and handling as would become second nature in use.

Thus, referring to the Drawings, the handlebars 10 for the standard motorcycle structure 12 are provided with a means, as in thumb-control levers 14, to operate controllable inflight-variable pitch propellers 16, 18. As illustrated, one such controllable inflight-variable pitch propeller 16 is housed in a duct 20 located forward of the handlebars 10, while a second controllable variable pitch propeller 18 is housed in a second duct 22 positioned rearwardly of the rider sitting in usual fashion on a seat 24. Both propellers 16 and 18 are above the center of gravity or center of mass of the motorcycle structure 12 with its rider in place. Located below each duct 20 and 22 are a pair of vanes 85 used for steering purposes.

More extensively, through the use of a means such as two separate hand operated controls 14 located on the handlebars 10, each of the controllable inflight-variable pitch propellers 16, 18 can be independently operated to produce more or less thrust as needed. As such, the front propeller is directed by one hand control 14 and the rear propeller 18 is directed by the other hand control 14 allowing for individualized thrust control capability. Each controllable inflight-variable pitch propeller 16 and 18 is housed inside ducts 20 and 22 for known propulsion benefits as well as noise reduction making this craft more useful near the public. Also in making this craft more useful, propellers 16 and 18 being above the center of mass to the craft and rider afford a positioning to aid in keeping the vehicle and rider upright and stable.

For purposes of left-to-right travel needed in steering, a means of directing the thrust generated by the variable pitching propellers 16 and 18 to the left or right of the craft will result in the craft's movement in the opposite left-or-right direction. Flat airfoils, also known by those skilled in the art as vanes 85, are located beneath each duct 20 and 22 in the flow of thrust, whereby swiveling the vanes 85 left-or-right will redirect the flow of thrust for the desired left or right turn. As will also be appreciated, means for redirecting the flow of thrust for purposes of steering can as well otherwise be devised without departing from the scope of the teachings.

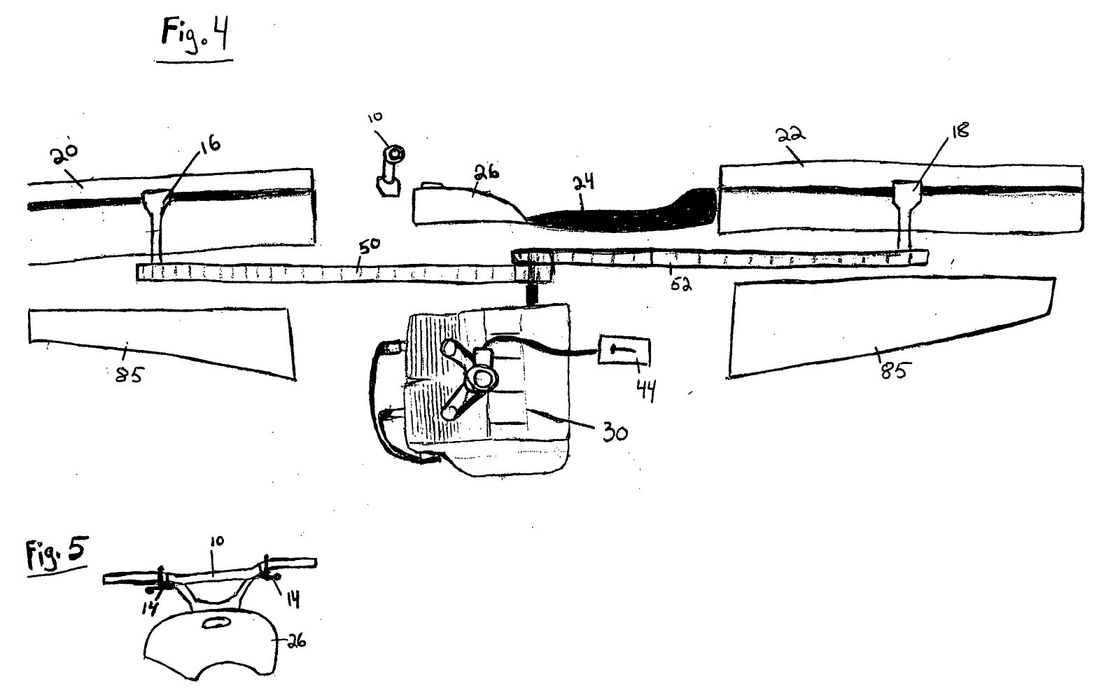

In understanding the construction of the craft from FIG. 4, the controllable inflight-variable pitch propellers 16 and 18 are powered through drive belts 50 and 52 by a gas engine 30 located below the seat 24 which receives fuel from a gas tank 26. Also in this particular illustration, located beneath the seat as well, an engine throttle switch 44 can be set to operate the engine at constant and maximum power to diminish lag in craft performance, as well as increase safety of the vehicle—in that craft stalling is very drastically lessened. Front and rear sets of vanes 85 are shown to be located under the front and rear ducts 20 and 22, the ducts 20 and 22 being known to house controllable inflight-variable pitch propellers 16 and 18 that can be controlled independently by the rider through the use of hand operated levers located at the handlebars 10. The handlebars 10 are also used by the rider to grasp while leaning and maneuvering the motorcycle structure 12 while in use.

As will thus be understood, the personal aircraft vehicle of the invention presents the appearance and function of a motorcycle in how an operator can use it. With one hand control (such as on the left handlebar), and with one hand control (as on the right handlebar), a rider can control the thrust capabilities of the front controllable inflight-variable pitch propeller and the rear controllable inflight-variable pitch propeller located in their respective ducts at the same time, or independently, for stability and usefulness of the craft. As well as in conventional motorcycle riding, one need only to lean into a turn, shifting their body weight along with using such means as the vanes to complete the maneuver of steering the craft.

The personal aircraft vehicle thus offers an easily attainable feel for control in a manner no more difficult to use than operating a conventional motorcycle.

While there has been described what is considered to be preferred embodiment of the present invention, it will be readily appreciated by those skilled in the art that modifications can be made without departing from the scope of the teachings herein. For at least such reason, therefore, resort should be had to the claims appended hereto for a true understanding of the scope of the invention.

I claim:

1. A personal aircraft vehicle comprising:
a wheel-less motorcycle frame incorporating a gasoline engine power system, a seat for a rider, and a pair of handlebars positioned forward of said seat;
first and second ducted propellers on said frame powered by said gasoline engine system respectively positioned forward of said handlebars and rearward of said seat;
means on said handlebar for varying the propulsion provided by said propellers in operation in upwards, downwards, and forwards motion of said motorcycle frame; and
with each of said propellers being at a height above a center of gravity of said frame with a rider in place on said seat.

2. The personal aircraft vehicle of claim 1 wherein a front bladed propeller is housed within said front duct.

3. The personal aircraft vehicle of claim 1 wherein a second bladed propeller is housed within said rear duct.

4. The personal aircraft vehicle of claim 1 wherein each of said ducted propellers includes a vane, and wherein said last mentioned means is controllable by a rider to swivel the vanes beneath where each ducted propeller quiescently rests.

5. The personal aircraft vehicle of claim 4 wherein said last mentioned means is controllable to swivel said vanes for left and right steering of said vehicle.

6. The personal aircraft vehicle of claim 1 wherein each of said ducted propellers includes a variable pitch bladed propeller and wherein said last mentioned means is controllable by a rider to vary the pitch presented by each of said bladed propellers.

7. The personal aircraft vehicle of claim 4 wherein said last mentioned means is controllable by a rider to vary the pitch of said first bladed propeller for upward and forward thrusting of said motorcycle frame.

8. The personal aircraft vehicle of claim 4 wherein said last mentioned means is controllable by a rider to vary the pitch of said second bladed propeller for upward and forward thrusting of said motorcycle frame.
